(19) United States
(12) Patent Application Publication
(10) Pub. No.: US 2005/0186991 A1
(43) Pub. Date: Aug. 25, 2005

(54) Wireless access point with enhanced coverage

(76) Inventor: Blaine R. Bateman, Louisville, CO (US)

Correspondence Address: HOLLAND & HART, LLP, 555 17TH STREET, SUITE 3200, DENVER, CO, 80201, US

(21) Appl. No.: 10/776,497

(22) Filed: Feb. 10, 2004

(51) Int. Cl. H04B 7/00

(52) U.S. Cl. 455/562.1; 455/129; 455/269

(57) ABSTRACT

The present invention provides an enhanced wireless access point. In particular, the enhanced wireless access point comprises at least one omni directional antenna and at least one ground plane. The at least one ground plane is arranged to cause the omni directional antenna to function as a directional antenna.

### FIELD OF THE INVENTION

The present invention relates to network connections and, more particularly, to a wireless network access point.

### BACKGROUND OF THE INVENTION

There has been a recent trend to develop wireless office and home networks (sometimes referred to as commercial or residential networks). FIG. 1 represents a conventional wireless network 100. Wireless network 100 comprises a wireless access point 102 and client devices 106₁₋ₙ. Client devices 106 may comprise, for example, a personal computer, a PDA, a cellular phone, a portable computer, a printer, an electronic game, or the like. Access point 102 is connected to a network 108. Network 108 is contemplated to be the World Wide Web or Internet, a private local area network, an Ethernet, a wide area network, or the like.

Access point 102 converts signals from network 108 to a wireless transmission protocol, such as WAP, 802.11, or bluetooth, and transmits the signals from access point antenna 110 to device 106. Device 106 also transmits signals that are received by access point 102. While shown as a cable connection, the connection between access point 102 and network 108 could be any conventional connection, such as a cable connection, a fiber optic connection, a wireless connection, or the like.

Conventionally, access point antenna 110 and device antenna 112₁₋ₘ are omni directional antennas. Referring now to FIG. 2, an office space 200 is shown, for example. Access point 102 and access point antenna 110 would be placed in the office space. Access point antenna 110, being omni directional, would produce a coverage area 202. As can be seen, because antenna 110 is omni directional, coverage area 202 can be split into two areas, proper coverage area 202p and improper coverage area 202i. Notice, the floor plan and coverage pattern are arbitrarily illustrated for exemplary purposes. Different access points, floor plans, and interfering devices would alter or change the coverage pattern. Often, using a single access point 102 results in floor plan 200 having a non-coverage area 204. Thus, client device 108₄ would be capable of accessing the network while client device 108₉ would not be capable of accessing the network or would only be capable of sporadic access. Further, client device 206 may be capable of accessing the network via improper coverage area 202i. Using multiple access points, non-coverage area 204 may be converted into proper coverage area 202p, but that may result in additional improper coverage area 202i.

Some higher end commercial access points 102 have removable omni directional antenna 110 that can be replaced with expensive high gain antenna. Replacing the omni directional antenna with a higher gain antenna decreases the non-coverage area 204 and increases the proper coverage area 202p, but is relatively expensive and may increase the improper coverage area 202i. Further, lower end access points 102 do not have removable omni directional antenna, but need to be specially modified with a switching circuit to accept a high gain antenna. Both of these options are expensive and difficult.

### SUMMARY OF THE INVENTION

To attain the advantages of and in accordance with the purpose of the present invention, an enhanced wireless access point is provided. The enhanced wireless access point comprises an access point with at least one omni directional antenna. At least one ground plane is arranged to be radio frequency coupled to the omni directional antenna such that the at least one omni directional antenna functions as a directional antenna.

The foregoing and other features, utilities and advantages of the invention will be apparent from the following more particular description of a preferred embodiment of the invention as illustrated in the accompanying drawings.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a functional block diagram of a wireless access point and wireless client devices for use in a network;

FIG. 2 is a floor plan illustrative of the wireless coverage areas associated with the network of FIG. 1;

FIG. 3 is a front plan view of an enhanced wireless access point illustrative of an embodiment of the present invention;

FIG. 4 is a side plan view of the enhanced wireless access point illustrative of an embodiment of the present invention;

FIG. 5 is a floor plan illustrative of the wireless coverage areas using the enhanced wireless access point shown in FIGS. 3 and 4;

FIG. 5A is a floor plan comparing the coverage of conventional wireless access points with an enhanced wireless access point consistent with the present invention;

FIG. 6 is a functional block diagram of a point-to-point network access in accordance with the present invention;

FIG. 7 is a front plan view of a enhanced wireless access point in accordance with at least another embodiment of the present invention;

FIG. 8A illustrates the radiation pattern viewed from a top plan view of a conventional wireless access point;

FIG. 8B illustrates the radiation pattern viewed from a top plan view of a enhanced wireless access point constructed in accordance with one aspect of the present invention;

FIG. 8C illustrates the radiation pattern viewed from a top plan view of a enhanced wireless access point constructed in accordance with another aspect of the present invention; and

FIGS. 9A-C illustrate the radiation patterns of the wireless access points of FIG. 8A to 8C viewed from a side plan view.

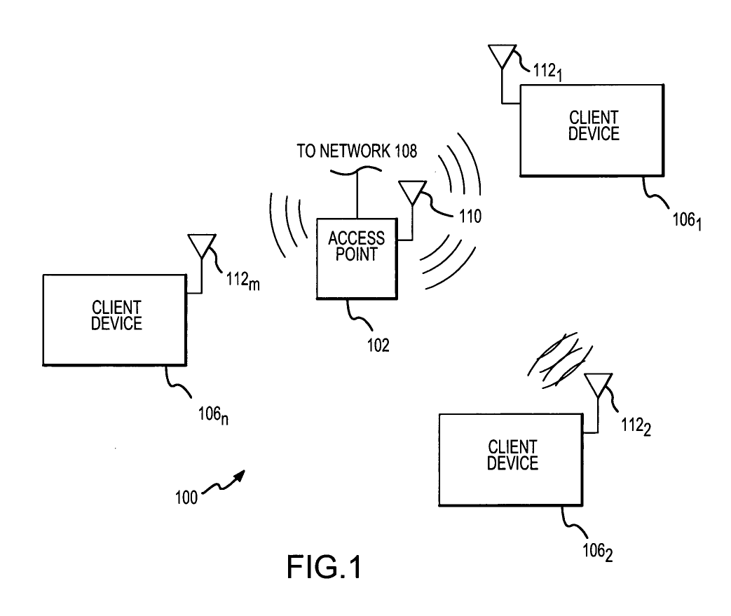

### DETAILED DESCRIPTION

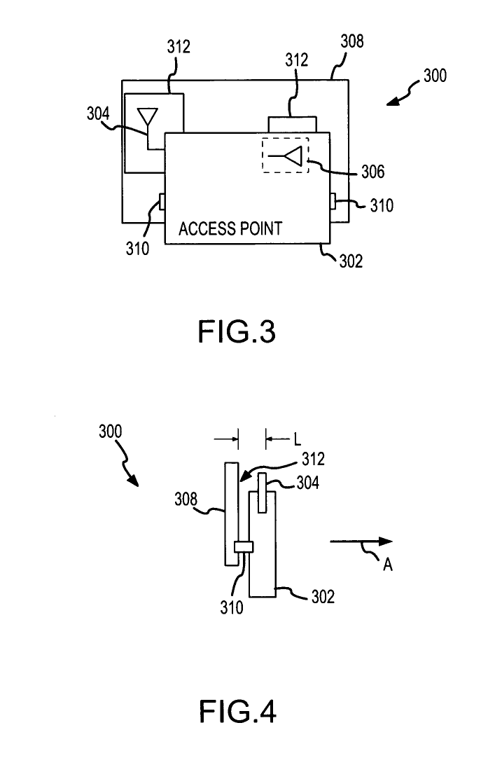

The present invention will now be described with reference to FIGS. 3 to 9C. FIG. 3 shows front plan view of a enhanced wireless access point 300 in accordance with the present invention. FIG. 4 shows a side plan view of a enhanced wireless access point 300. Enhanced wireless access point 300 contains a conventional access point 302 and provisions for ground planes 312, as will be described further. Access point 302 contains a conventional omni directional access point antenna 304. Access point antenna 304 is normally a conventional dipole omni directional antenna, but could be other types of omni directional antenna, such as, for example, a multiband dipole antenna, PLB micro strip antenna, PIFA, dielectric antenna, and the like. Optionally (and desirably), access point 302 also comprises a second omni directional antenna 306 shown in phantom. As shown, second omni directional antenna 306 is oriented perpendicular to antenna 304, but this is not necessary to obtain the benefits of the present invention. Access points 302 are typically designed with two or more equivalent antenna to reduce antenna interference due to multipath fading and to provide diversity, such as, for example, polarization and pattern diversity. Multipath fading and diversity are generally understood in the art and will not be further explained herein.

A substrate 308 is mounted to access point 302 by connectors 310. Connectors 310 are shown generically; however, connectors 310 can be any conventional means of mounting substrate 308 to access point 302, such as a welded connection, a integral injection molded part, screws, a rail and guide, clamps, clips, or the like. Further substrate 308 could be fashioned as a mounting bracket, or the like, for access point 302 such that access point could be releasably coupled to substrate 308. In fact, while shown connected for convenience, substrate 308 and access point 302 do not need to be physically connected although the physical connection helps ensure proper location of substrate 308 in relation to the antenna or antennas. Further, while substrate 308 and ground plane 312 are shown to have a rectangular shape, any shape is possible as a matter of design and aesthetic choice. Alternatively to substrate 308, access point 302 could have a back plane with ground planes 312 mounted on the back plane (moreover, access point 302 could have multiple back planes with various combinations of ground planes or no ground plane for alternative uses).

Mounted on substrate 308 is a ground plane 312. Substrate 308 is optional for ease of placing individual ground planes 312, but ground planes 312 could be mounted without the use of separate substrate 308. Substrate 308 and ground plane 312 could be any number of materials as are known in the art, such as, for example, RF conductive materials, plastics, metals, metal foils, and the like or combinations thereof. Further, as shown, when the second omni directional antenna 306 is used, multiple ground planes 312 could be placed. In the case of multiple antenna, instead of using multiple ground planes, a single ground place could be placed that operates as the ground plane for each antenna. Alternatively, select ones of the antenna could have ground planes and the other antennas could be mounted without ground planes.

Ground plane 312 is mounted a distance L from omni directional antenna(s) 304 (and 306). Desirably, the distance L is ¼ wavelength. While other distances could be used, a distance of ¼ wavelength seems to provide the best results. For multiband antennas, it is not possible to maintain L to be ¼ wavelength for all frequency bands, but the benefits of the present invention are still obtained for miltiband antennas. In this case, L is less then ¼ wavelength for some frequency bands, while L may be greater than ¼ wavelength for other frequency bands. Ideally ground plane 312 should be about ½ wavelength in width, but could be more or less as a matter of choice. While ground plane 312 could have any number of larger dimensions, such as if you wished to have a single ground plane for multiple antenna in enhanced wireless access point 300. The maximum size of the ground plane is largely limited by practicality, cost, and aesthetics. Conversely, the width of the ground plane is limited in minimum size to a size that would still function like a ground plane. The minimum effective width depends on the antenna type, as well as the desired gain improvement and the spacing L, but ½ wavelength is known to be generally effective.

As one of ordinary skill in the art would now recognize, using ground planes 312 converts the relatively lower gain omni directional antenna 304 and the optional relatively lower gain omni directional antenna 306 into relatively higher gain directional antennas directed as shown by arrow A. Further, strategic placement of ground plane 312 behind antenna 304 and/or 306 allows for steering of the direction.

If substrate 308 is removably connected to access point 302, such as when connectors 310 are snap lock connectors, clamps, or guides, access point 302 is convertible between a relatively lower gain omni directional device and a relatively higher gain directional device, without the addition of expensive removable antennas, electrical connections, cables, and the like.

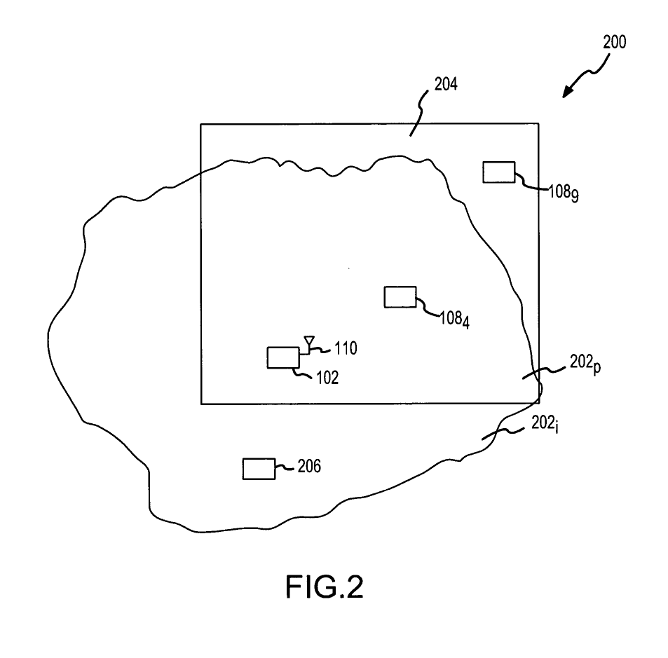

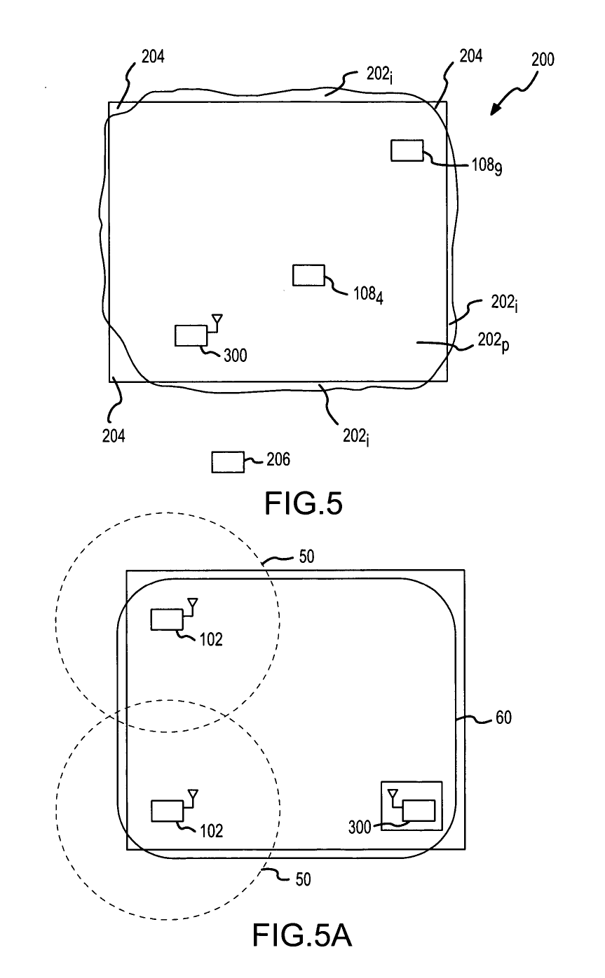

Referring now to FIG. 5 showing floor plan 200 from FIG. 2 with enhanced wireless access point 300 instead of access point 102 and access point antenna 110, it is seen that proper coverage area 202p is arranged over more of floor plan 200. Using the enhanced wireless access point 300, non-coverage area 204 is relatively limited to small areas of the floor plan, and improper coverage area 202i is greatly reduced. As a result of the coverage changes, client device 108₉ is capable of accessing the network and client device 206 is incapable of accessing the network via improper coverage areas. Thus, using the ground plane provides some ability to adjust and direct coverage area, improving performance or enhancing security. Notice, the floor plan and coverage patterns are arbitrarily illustrated and should be considered for exemplary purposes only.

Referring to FIG. 5A, showing a floor plan of a long or extended area for which coverage is desired, the plan view of two possible coverage schemes is shown. In the case where conventional access points 102 are used, two or more access points are needed to provide the desired coverage which is shown in phantom as coverage area 50. In the case of the present invention, enhanced access point 300 can be used to cover the entire area without the additional expense of more access points, which coverage area of enhanced access point 300.3 shown as coverage area 60.

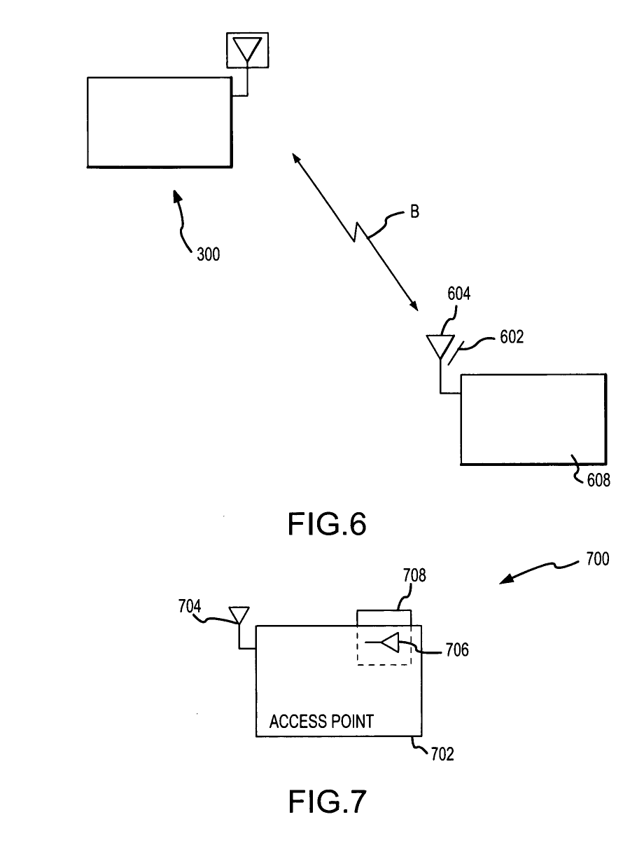

Referring now to FIG. 6, using wireless gateway 300 and adding a ground plane 602 to an omni directional antenna 604 of client device 606 makes both the gateway 300 and client device 606 directional, as shown by arrow B. Thus, using multiple ground planes, it is possible to change a conventional multiple access wireless network into a point-to-point network.

Referring now to FIG. 7, a combination wireless gateway 700 is shown. Combination wireless gateway 700 comprises an access point 702, a first access point antenna 704, a second access point antenna 706, and one ground plane 708 associated with second access point antenna 706. In this case, placement of ground plane 708 causes omni directional second access point antenna 706 to function as a directional antenna, which direction can be steered by placement of ground plane 708. First access point antenna 704, while influenced in part by ground plane 708, generally continues to function as a relatively lower gain omni directional antenna.

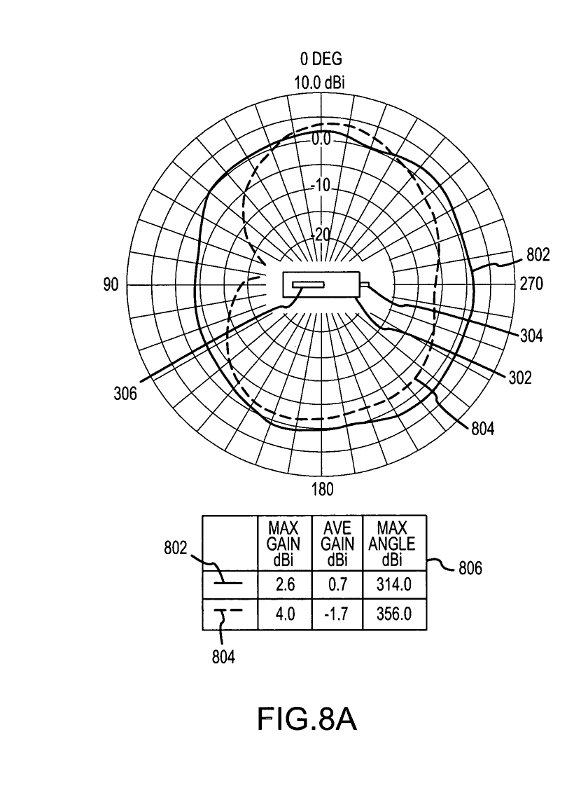

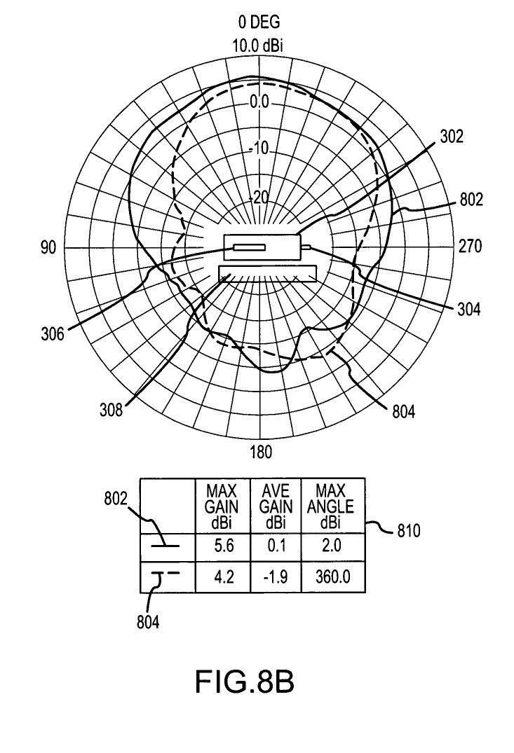

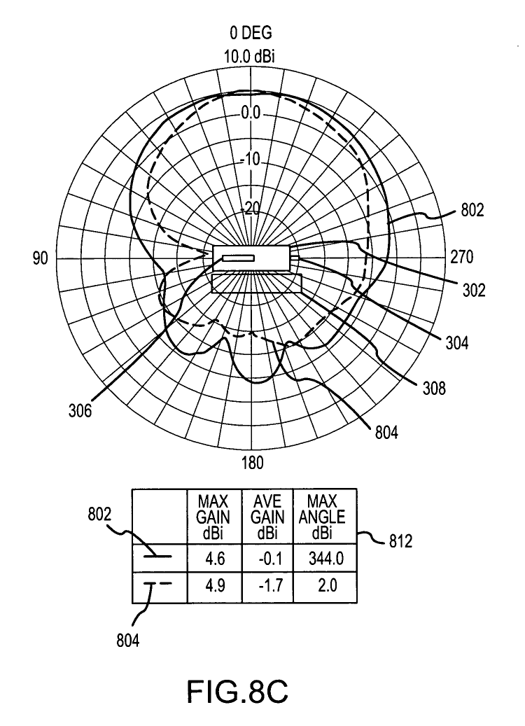

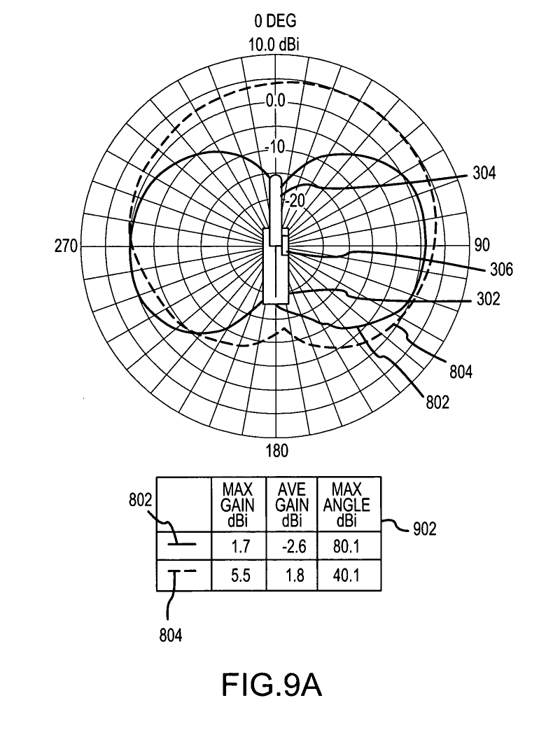

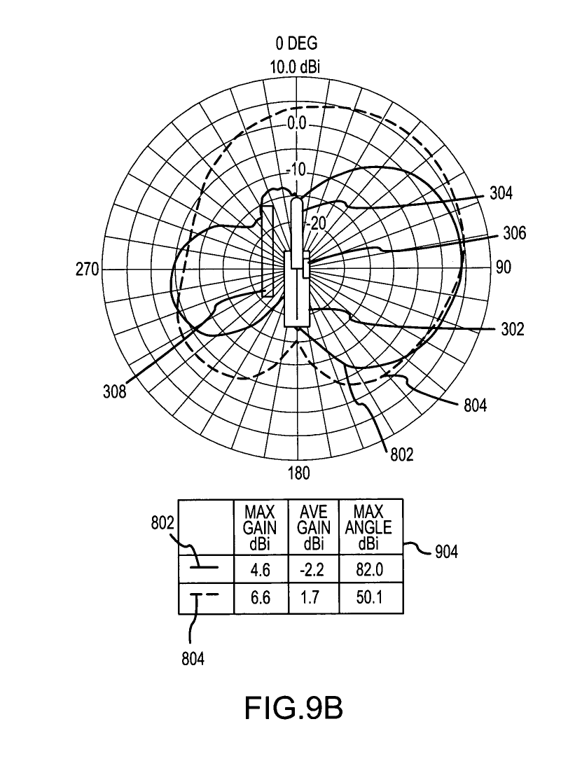

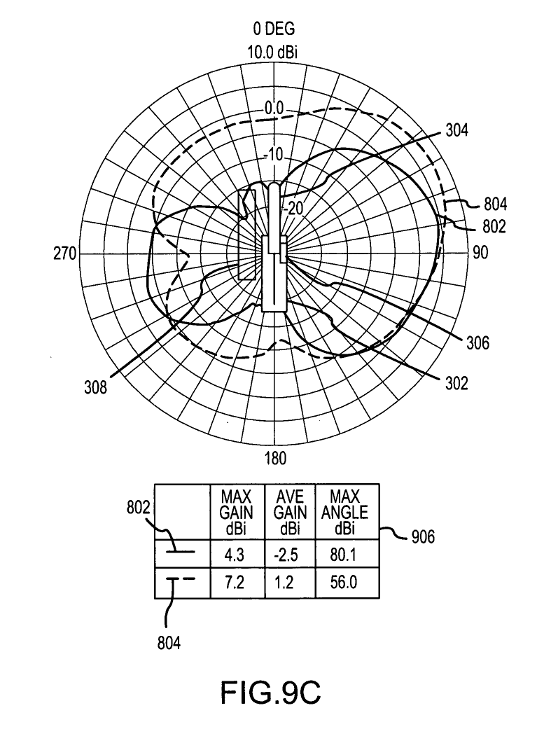

Referring now to FIGS. 8A to 8C, radiation patterns of wireless gateways are described. Referring first to FIG. 8A, a wireless gateway 302 is shown. Wireless gateway 302 has a first antenna 304 and a second antenna 306. First antenna 304 has an omni directional radiation pattern 802. Second antenna 306 has a radiation pattern 804. For this particular arrangement, table 806 identifies the maximum gain, average gain and maximum angle degree associated with the radiation pattern, from this view. FIG. 8B shows how radiation pattern 802 is modified by placing substrate 308 and ground planes 312 about first antenna 304 and second antenna 306. Table 810 shows the gains and angle degree associated with the modified radiation pattern. As can be seen, the gains of the antenna increased. Finally, referring to FIG. 8C, when the ground plane on substrate 308 is shifted, it is seen the radiation patterns 802 and 804 can be further modified or steered, resulting in the gains shown in table 812. FIGS. 9A to 9C show radiation patterns consistent with FIGS. 8A to 8C, but from a side plan view instead of a top plan view. Tables 902, 904 and 906 reveal associated gains and angles for this particular embodiment. Referring specifically to FIGS. 9B and 9C, the steer ability of the radiation pattern is seen by the shift in pattern 804.

In the case of FIG. 9C, the ground plane for antenna 306 was moved up, resulting in steering the pattern 804 from 50 to 56 degrees and increasing the gain from 6.6 to 7.2 dB.

While the invention has been particularly shown and described with reference to an embodiment thereof, it will be understood by those skilled in the art that various other changes in the form and details may be made without departing from the spirit and scope of the invention.

1. A enchanced wireless access point, comprising:
an access point;
at least one omni directional antenna; and
at least one ground plane radio frequency coupled to at least one of the at least one omni directional antenna, wherein
the at least one omni directional antenna functions as a directional antenna.

2. The wireless gateway according to claim 1, wherein the at least one omni directional antenna comprises at least one of a dipole, a monopole, a printed circuit board antenna, a planar inverted F antenna, a multiband dipole, a PLB microstrip antenna, and a dielectric antenna.

3. The wireless gateway according to claim 1, wherein the at least one omni directional antenna comprises a plurality of omni directional antennas.

4. The wireless gateway according to claim 3, wherein the plurality of omni directional antennas are arranged to provided diversity.

5. The wireless gateway according to claim 2, wherein the at least one ground plane comprises a plurality of ground planes.

6. The wireless gateway according to claim 1, wherein the at least one omni directional antenna comprises a first number of omni directional antennas and the at least one ground plane comprises a second number of ground planes where the first number of omni directional antenna is larger than the second number of ground planes.

7. The wireless gateway according to claim 1, wherein the at least one omni directional antenna comprises two omni directional antennas arranged to provided diversity.

8. The wireless gateway according to claim 7, wherein the at least one ground plane comprises one ground plane associated with one of the two omni directional antennas.

9. The wireless gateway according to claim 7, wherein the at least one ground plane comprises two ground planes, each ground plane associated with a respective one of the omni directional antennas.

10. The wireless gateway according to claim 1, further comprising:
at least one substrate;
the at least one ground plane is mounted on the substrate; and
the at least one substrate is releasably coupled to the access point.

11. The wireless gateway according to claim 1, wherein the access point comprises a back plane and the at least one ground plane is mounted on the back plane.

12. The wireless gateway according to claim 1, wherein the at least one ground plane is placed to steer a radiation pattern associated with the at least one omni directional antenna.

13. A wireless gateway, comprising:
an access point;
means for providing an omni directional radio frequency pattern; and
means for converting the omni directional radio frequency pattern to a directional radio frequency pattern.

14. The wireless gateway according to claim 13, wherein the means for providing is at least one omni directional antenna.

15. The wireless gateway according to claim 13, wherein the means for converting is at least one ground plane.

16. The wireless gateway according to claim 13, wherein the means for converting is about ¼ wavelength from the means for providing.

17. A wireless gateway, comprising:
an access point;
the access point adapted to connect to a network;
a bracket;
the bracket releasably coupled to the access point; and
the access point further comprises:
a first omni directional antenna; and
a second omni directional antenna;
the bracket further comprises:
a first ground plane;
such that when the bracket is releasably coupled to the access point, the first ground plane causes the first omni directional antenna to exhibit a first directional antenna radiation pattern.

18. The wireless gateway according to claim 17, wherein the first ground plane causes the second omni directional antenna to exhibit a directional antenna radiation pattern.

19. The wireless gateway according to claim 17, wherein the bracket comprise a second ground plane and the second ground plane causes the second omni directional antenna to exhibit a section directional antenna radiation pattern.

20. The wireless gateway according to claim 17, wherein when the bracket is releasably coupled to the access point, the first ground plane is about ¼ wavelength from the first omni directional antenna.
